(19) United States
(12) Patent Application Publication
(10) Pub. No.: US 2016/0117074 A1
(43) Pub. Date: Apr. 28, 2016

(54) AREA INPUT DEVICE AND VIRTUAL KEYBOARD

(71) Applicant: T+Ink, Inc., New York, NY (US)

(72) Inventors: John Gentile, Montclair, NJ (US); Terrance Z. Kaiserman, Loxahatchee, FL (US); Steven Martin Cohen, New York, NY (US); Anthony Gentile, New York, NY (US)

(73) Assignee: T+Ink, Inc., New York, NY (US)

(21) Appl. No.: 14/713,976

(22) Filed: May 15, 2015

Related U.S. Application Data
(60) Provisional application No. 61/993,501, filed on May 15, 2014.

(51) Int. Cl. G06F 3/0488; G06F 3/044; G06F 3/0481

(52) U.S. Cl. CPC G06F 3/0488; G06F 3/04815; G06F 3/04886; G06F 3/044

(57) ABSTRACT

Input devices, particularly devices for entering data within three-dimensional space and converting that data into one or more commands, are provided.

### RELATED APPLICATIONS

This application claims priority to U.S. Provisional Application No. 61/993,501, filed May 15, 2014, which is incorporated herein by reference in its entirety.

### FIELD

The present disclosure relates to input devices, particularly devices for entering data within three-dimensional space and converting that data into one or more commands.

### BACKGROUND OF INVENTION

There are many devices for entering data into computers and other digital machinery. For example, keyboards are arrays of switches, with each switch or key representing a different alphanumeric character such that sequences of key pressings can produce words and sentences.

The Theremin was invented in the first half of the 20^{th} century, and this was the first input device that could sense hand position by using the hand as part of the tuning circuit of a high frequency oscillator, which when mixed with a second oscillator produced a resultant audio frequency that could be controlled as a function of hand position.

### SUMMARY OF INVENTION

The present invention relates to input devices and, in particular, devices for entering data within three-dimensional space and converting that data into one or more commands. The subject matter of the present invention involves, in some cases, interrelated products, alternative solutions to a particular problem, and/or a plurality of different uses of one or more systems and/or articles.

In some embodiments a system for extracting hand distance and/or position across and/or above a surface is provided. The system comprises a substrate; at least one capacitive plate; circuitry configured to produce measurable change of a parameter as a function of capacitance of said at least one capacitive plate; a source of power; and a processor.

In some embodiments, a method is provided. The method comprises transforming one path function of a hand through at least one dimensional space into at least one different path function in at least one dimensional space.

In some embodiments, a system is provided. The system comprises a substrate and a capacitive plate, wherein the capacitive plate has a capacitance that can be altered by the presence of a human body part that is not in direct contact with the capacitive plate. The system further comprises one or more electronic devices, wherein the one or more electronic devices configured to produce a measureable change of a parameter as a function of the capacitance of the capacitive plate.

In some embodiments, a system is provided for extracting hand distance and/or position across and/or above a surface. The system comprises a substrate; at least one moveable capacitive plate that can rotate into and out of the plane of said substrate; circuitry configured to produce measurable change of a parameter as a function of capacitance of said at least one capacitive plate; a source of power; and a processor.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

FIG. 1 shows a planar substrate and a capacitive element.

FIG. 2 shows a side view of a capacitive element and different radial distances from the capacitive element.

FIG. 3 shows a planar substrate and two capacitive elements.

FIG. 4 shows a side view of two capacitive elements and different radial distances from both capacitive elements.

FIG. 5 shows a three dimensional view of two capacitive elements on an xyz coordinate system, and a constant radial distance from both capacitive elements.

FIG. 6 shows a planar substrate and three capacitive elements.

FIG. 7 shows three capacitive elements in a plane, and three radial distances from each respective capacitive element intersecting at a point.

FIG. 8 shows a planar substrate and four capacitive elements.

FIG. 9 shows four capacitive elements in a plane, and four radial distances from each respective capacitive element intersecting at a point.

FIG. 10 shows an xyz coordinate system, an area in the xy plane, and a planar map into three dimensional space.

FIG. 11 shows an xyz coordinate system, an area in the xy plane, and a curved map into three dimensional space.

FIG. 12 shows a planar substrate and a pair of capacitive electrodes folded into the planar substrate.

FIG. 13 shows a planar substrate and a pair of capacitive electrodes folded upward and perpendicular to the planar substrate.

FIG. 14 shows a planar substrate and four capacitive electrodes folded upward and perpendicular to the planar substrate.

### DETAILED DESCRIPTION

Certain embodiments are directed to a system for extracting hand distance and/or position across and/or above a surface. The system can be used to construct a virtual keyboard in three-dimensional space, with hand gestures and paths through space creating unique sequences of commands that can control any number of things, from entering data into a virtual keyboard to controlling room lighting, changing TV channels, calling a phone number, or any function that presently involves interaction with a computer or smart device.

In some embodiments, the system comprises at least one capacitive plate. The capacitive plate can be part of an electrical circuit. In some cases, the system further comprises circuitry (e.g., one or more electronic devices) capable of producing measureable change of a parameter as a function of capacitance of the at least one capacitive plate. In some embodiments, the system comprises an inductor. The system can also comprise a substrate, a source of power (e.g., a power supply), and a processor.

In some embodiments, the substrate can be contained within a plane and/or near planar surface. In some cases, the substrate can be flexible. The substrate can be inserted into and/or attached to printed material, including but not limited to cards, greeting cards, magazines, newspapers, books, brochures, and advertising. In some embodiments, the substrate can be mounted to boxes, trays, windows, posters, walls, point of purchase displays, billboards, and/or areas that can be seen.

The capacitive plate can be any element capable of forming one plate of a capacitor. In some embodiments, the capacitive plate is printed, etched, deposited, discrete, in-molded, adhesively applied, laminated within, molded, cast, and/or stamped. In some cases, the capacitive plate is a conductive substrate, a weldment, a fabrication, an assembly, a subassembly, and/or any metallic and/or conductive element capable of forming one plate of a capacitor. The metallic and/or conductive element capable of forming one plate of a capacitor can be more than one metallic and/or conductive element electrically connected together to collectively form one plate of a capacitor. For example, the metallic and/or conductive element can be a conductive peg and/or grouping of pegs, a shelf and/or a shelving unit, and/or a structure. In some embodiments, the metallic and/or conductive element is in contact with one or more other conductive and/or non-conductive objects. There can be two, three, four, or more than four capacitive plates.

In some embodiments, the capacitive plate has a capacitance that can be altered by the presence of a human body part that is not in direct contact with the capacitive plate. Non-limiting examples of a human body part include a finger, a hand, a toe, and/or a leg. In some cases, the change in capacitance resulting from the presence of a human body part can result in measurable change of at least one parameter. Examples of parameters include, but are not limited to, frequency, voltage, capacitance, inductance, coupling, circuit Q (e.g., the quality factor, the Q factor), quantifiable electromagnetic and/or electrostatic field distortion, and/or any of the above. In some embodiments, a capacitive plate and/or inductor exhibits the behavior of a lumped parameter system. The lumped parameter system can have distributed inductive, conductive, and/or resistive properties that are partially or wholly influenced in a quantifiable manner by the proximity of a human body part over a range of body part distances, positions, and/or radii.

In some embodiments, a measurable change of at least one parameter as a function of capacitance of the capacitive plate can be quantified over a range of body part distances and/or positions. In some cases, the measureable change of at least one parameter produces at least one variable value representing at least one radius from at least one capacitive plate. At least one radius can be a plurality of radii producing at least one shell in three-dimensional space that maps a constant measurable change of a parameter. In some embodiments, at least one shell in three-dimensional space can be two shells in three-dimensional space. In certain cases, the intersection of two shells can be at least one locus of points along an arc in three-dimensional space above the substrate. In certain embodiments, at least one shell in three-dimensional space can be at least three shells in three-dimensional space. In some cases, the intersection of three shells in three-dimensional space can be at least one location in three-dimensional space above the substrate. In some embodiments, the at least one capacitive plate can be four or more capacitive plates. Four or more capacitive plates can provide redundancy for position sensing due to the fact that multiple combinations of three capacitive plates can be used to create overlapping solutions that can be averaged and/or averaged in a weighted manner. In some embodiments, at least one location in three-dimensional space can be used to produce a linearized position by application of at least one mathematical equation and/or can be used to produce a map that is position-linearized by application of at least one mathematical equation. At least one location in three-dimensional space can be contained within an array of at least one dimension. In some embodiments, the array of at least one dimension can correspond to a plurality of body part positions and/or locations. At least one location in three dimensional space can be contained within an array of two dimensions. At least one location in three dimensional space can be contained within an array of three dimensions.

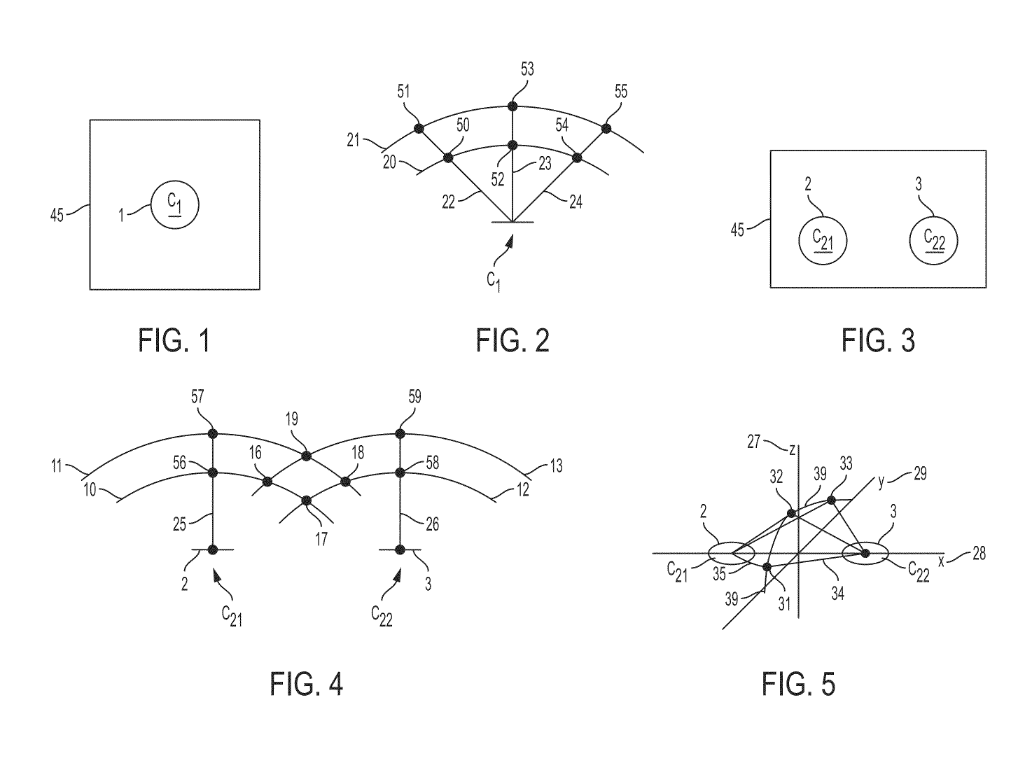

FIG. 1 shows an exemplary embodiment comprising a capacitive plate 1 located in a substrate plane 45. A side view of the embodiment of FIG. 1 is shown in FIG. 2. In FIG. 2, different constant radial distances from capacitive plate 1 are shown. Small radius arc 20 and large radius arc 21 each show an approximate path along which a constant signal would be derived from distance-sensing circuitry (not shown). In some cases, the radial arc along which a constant signal would be derived is not exactly constant because as the angle deviates from perpendicular as indicated by the normal radial line 23, the foreshortening exposure of capacitive plate 1 alters the distance the body part must be located at to obtain the same signal. FIG. 2 also shows left radial line 22 and right radial line 24. Also shown in FIG. 2 are intersection 50 between left radial line 22 and small radius arc 20, intersection 51 between left radial line 22 and large radius arc 21, intersection 52 between normal radial line 23 and small radius arc 20, intersection 53 between normal radial line 23 and large radius arc 21, intersection 54 between right radial line 24 and small radius arc 20, and intersection 55 between right radial line 24 and large radius arc 21.

FIG. 3 illustrates an exemplary embodiment comprising two capacitive elements. In FIG. 3, first capacitive plate C21 (2) and second capacitive plate C22 (3) are positioned in substrate plane 45. FIG. 4 shows a cross-sectional side view of the system of FIG. 3. FIG. 4 shows a small radius arc 10 from capacitive plate C21, which demonstrates an arc along which distance from capacitive plate C21 is constant. FIG. 4 also shows a large radius arc 11 from capacitive plate C21, where large radius arc 11 has a larger radius than small radius arc 10. Also shown are normal radial line 25, intersection 56 between small radius arc 10 and normal radial line 25, and intersection 57 between large radius arc 11 and normal radial line 25. FIG. 4 also shows small radius arc 12 and large radius arc 13, both from capacitive plate C22, which demonstrate arcs along which distance from capacitive plate C22 is constant. Also shown in FIG. 4 are normal radial line 26, intersection 58 between small radius arc 12 and normal radial line 26, and intersection 59 between large radius arc 13 and normal radial line 26. FIG. 4 also shows that the four arcs intersect each other at four points: intersection 16 between small radius arc 10 from capacitive plate C21 and large radius arc 13 from capacitive plate C22, intersection 17 between small radius arc 10 from capacitive plate C21 and small radius arc 12 from capacitive plate C22, intersection 18 between large radius arc 11 from capacitive plate C21 and small radius arc 12 from capacitive plate C22, and intersection 19 between large radius arc 11 from capacitive plate C21 and large radius arc 13 from capacitive plate C22.

FIG. 5 shows a three-dimensional view of capacitive plate C21 (2) and capacitive plate C22 (3). In FIG. 5, capacitive plates C21 and C22 are located within an xy plane formed in an xyz coordinate system formed by x-axis 28, y-axis 29, and z-axis 27. FIG. 5 shows an equidistant arc 39 between capacitive plates C21 and C22 (e.g., any point along constant radius arc 39 is the same distance from capacitive plate C21 as from capacitive plate 22). Radius 35 represents the radius between capacitive plate C21 and equidistant arc 39, and radius 34 represents the radius between capacitive plate C22 and equidistant arc 39. In some cases, any position of a body part along constant radius arc 39 between capacitive plates C21 and C22 can produce the same signal. For example, in certain embodiments, first point 31 on arc 39 can produce the same signal as second point 32 on arc 39 and third point 33 on arc 39.

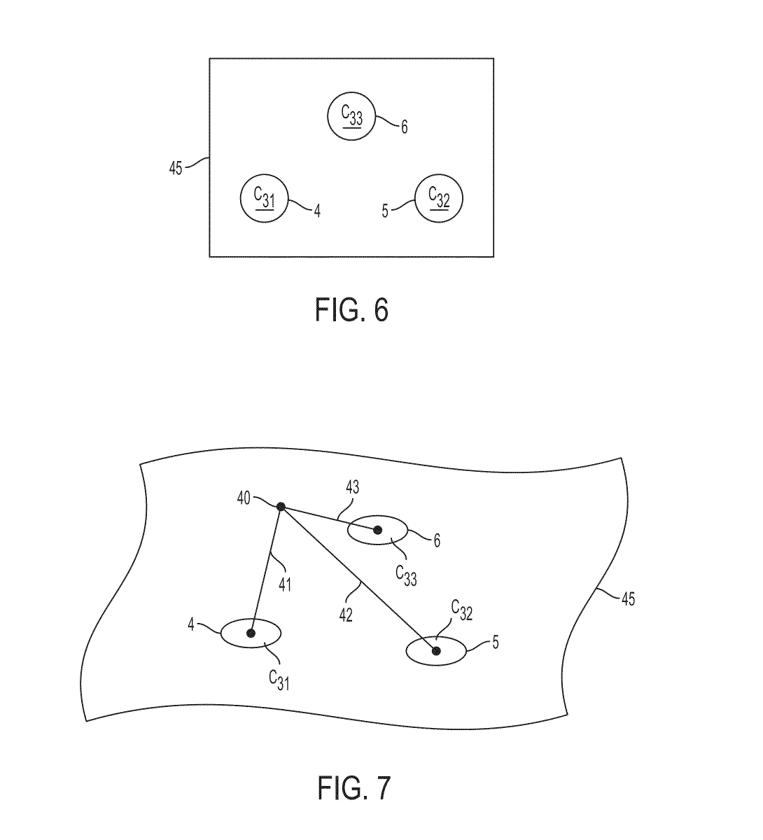

In some embodiments, a system comprises three capacitive plates. It may be advantageous, in some cases, to use three capacitive plates to solve the problem of multiple positions along an arc producing the same signal. FIG. 6, which illustrates an exemplary system comprising three capacitive plates, shows a substrate plane within which capacitive plates are located 45, capacitive plate C31 (4), capacitive plate C32 (5), and capacitive plate C33 (6). FIG. 7 shows a three-dimensional view of the system of FIG. 6, illustrating substrate plane 45, capacitive plate C31 (4), capacitive plate C32 (5), and capacitive plate C33 (6). FIG. 7 also shows a radial line 41 from capacitive plate C31, a radial line 42 from capacitive plate C32, and radial line 43 from capacitive plate C33. Radial lines 41, 42, and 43, which all have the same length, intersect at point 40. FIG. 7 thus demonstrates that equidistant radial lines from three capacitive plates can intersect at a point instead of an arc.

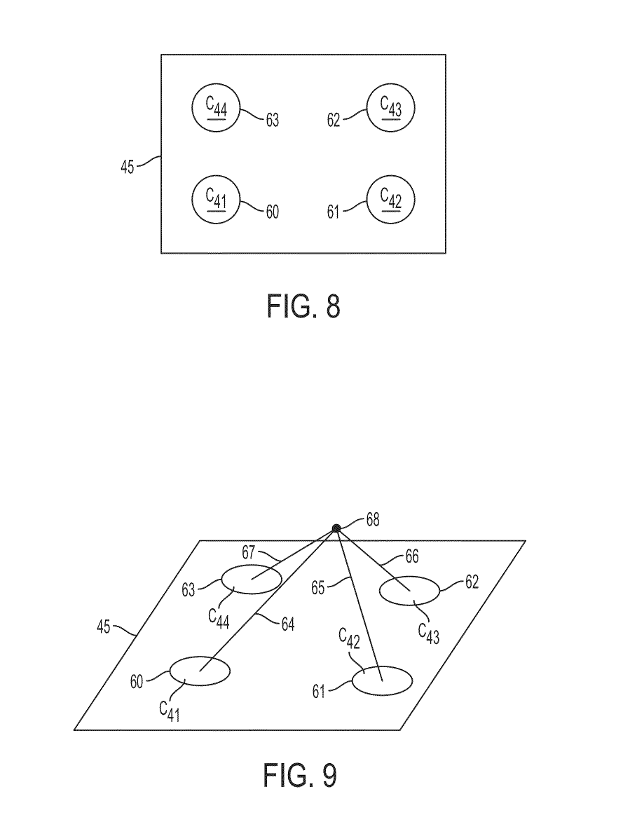

In some embodiments, a system comprises four capacitive plates. FIG. 8 shows the substrate plane within which capacitive plates are located 45 and four capacitive elements: capacitive plate C41 (60), capacitive plate C42 (61), capacitive plate C43 (62), and capacitive plate C44 (63). A four plate system can have added redundancy for position sensing because there are multiple combinations of three capacitive plates that can be used to cross check each other's position. FIG. 9, which shows the system of FIG. 8, shows substrate plane 45, the four capacitive elements C41, C42, C43, and C44, radial line 64 from capacitive plate C41, radial line 65 from capacitive plate C42, radial line 66 from capacitive plate C43, and radial line 67 from capacitive plate C44. From FIG. 9, it can be seen that radial lines 64, 65, 66, and 67, which all have the same length, intersect as point 68. FIG. 9 again demonstrates that equidistant radial lines from four capacitive plates can intersect at a point instead of an arc.

In some embodiments, the system comprises circuitry (e.g., one or more electronic devices) capable of producing measureable change of a parameter as a function of capacitance. In some cases, the circuitry comprises a first oscillator. The first oscillator can produce a reference frequency. In certain cases, the circuitry further comprises a second oscillator. The second oscillator can produce a dependent frequency as a function of at least one capacitive plate and/or at least one inductor. In some cases, the system comprises a mixer. The mixer can combine a reference frequency and a dependent frequency to produce a beat frequency proportional to the difference in frequency and/or sum and difference frequency between the reference frequency and the dependent frequency. In certain embodiments, the first oscillator is automatically frequency nulled and/or adjusted to compensate for drift between differences in frequency and/or the sum and difference frequency. In some embodiments, the first oscillator and/or second oscillator is connected to at least one conductor. In some cases, the at least one conductor is connected (e.g., electrically connected) to a first capacitive element. In some embodiments, the system further comprises a second capacitive element. The system may, in some cases, comprise circuitry to detect coupling of frequency signal to the second capacitive element. In some embodiments, the circuitry can relate the magnitude of the coupling to a range of distances between the first capacitive element and second capacitive element. In some cases, the first capacitive element and the second capacitive element are in the same plane (e.g., xy plane). In some cases, the first capacitive element and second capacitive element are in different planes (e.g., different layers).

In some embodiments, there is a function (e.g., a mathematical function) that can translate a position of a human body part (e.g., location in three-dimensional space) to a variable (e.g., a mathematical variable). In certain cases, the function is a point function. A point function generally refers to a function of points (e.g., locations) in one-, two-, or three-dimensional space. For example, the presence of a human body part at a particular location can initiate a specific action or function. In some cases, the point function is path-independent (e.g., the point function can be a location in space relative to another location in space without regard to the path through space to get from one location to another). In some embodiments, the point function is an error-corrected point function. The point function can, in some cases, be dependent on absolute position relative to at least one capacitive plate. In some cases, the point function is a function of body part position relative to a previous body part position.

In some cases, a function of body part distance and/or position in three-dimensional space is a path function. A path function generally refers to a function that is dependent on the path through space that a body part travels to get from a first location in space to a second, different location in space. There are an infinite number of paths to get from any arbitrary point in space to any other arbitrary point in space, and in some cases, the path taken can serve as an address to initiate a specific action. In certain embodiments, at least one path function is a plurality of concatenated point functions. In some cases, the path function is an error-corrected path function.

An error-corrected function (e.g., an error-corrected point function and/or an error-corrected path function) generally refers to a function having the ability to learn and make improved best choices. For example, choices can be based on statistical incidence of error deviation as a function of position and/or path and correlation with desired function command.

In some embodiments, error correction for path functions generated by hand movement can employ application of a best fit for spatial shorthand gestures. Shorthand gestures can enable an efficient keyboard map to be generated to minimize motion to word transforms (e.g., typing a word, which involves going from letter to letter to type a word). The error correction can allow a sloppiness function to be settable such that a single letter can incorporate a certain radius of other letters, and movement of the hand to the second letter in a word can have as the second letter target a certain radius of other letters, and so on with the third letter. In some embodiments, best fit error correction can be incorporated such that any letter within the set of the first letter's zone of ambiguity followed by any letter within the set of the second letter's zone of ambiguity followed by subsequent letters and their associated zones of ambiguity can then produce best fit words. In some cases, the best fit words can be selected such that a shorthand with learning develops to enable faster entry of typed information from a virtual keyboard.

In some embodiments, at least one function can define at least one address for and/or can initiate at least one function command. As used herein, a function command refers to a command to perform a function (e.g., typing a letter on a keyboard, raising the volume of sound, increasing the brightness of a light). The function may be any function that can be controlled by an input device. In some embodiments, the function command comprises a series of motions performed by a body part. For example, in a particular, non-limiting embodiment, making the shape of the letter S tilted at a 45 degree angle can create a function command to turn off an air conditioner. In another example, raising the hand three inches at a specific location can create a function command to dim a light from full brightness. In yet another example, moving a hand around can cause a cursor to move across a screen. Examples of function commands include, but are not limited to, commands that control: typing, input to musical instruments, generating midi output, controlling analog levels such as sound volume, channel tuning, pitch bending, filter center frequencies and/or cutoff frequencies, environmental controls, temperature, humidity, game control, steering, acceleration, breaking, flying, elevator, rudder, aileron, flap, landing gear, firing of weapons and/or ordinance, launching missiles, color control and/or color specification and/or lighting control, computer graphics control of any graphic parameters, real time control, input control of any parameter that can be represented and/or controlled by an analog and/or digital position, robotic and/or machinery manipulation, course tuning controls, fine tuning controls, and/or other functions typically initiated by a plurality of input devices presently used. In some embodiments, a function command controls more than one analog level by segregating more than one region in 3D space and mapping into a 1D range with a beginning of a range and an end of a range and multiple levels in between. A 1D range can be at least one of the following: a linear map, a logarithmic map, and/or a user settable map. The 1D range can be oriented along any curve in space, where one point on the curve can represent the beginning of the range of 1D control and another point can represent the end of the range of 1D control. In some cases, there can be multiple points between the beginning and the end that are either monotonically increasing between the beginning and end or track any function of a single parameter to yield a result between the beginning and end of the range.

In some embodiments, a plurality of function commands form an array of function commands. The plurality of function commands can, in certain cases, create a virtual keyboard. In some embodiments, the virtual keyboard is scaleable in size. The function command can, in some embodiments, be a user-defined function command. In some cases, the user-defined function command can wholly or partially be contained within an array of function commands. In some cases, the user-defined function command can be wholly or partially contained within a virtual keyboard.

In some cases, at least one path function is transformed into at least one different path function. For example, a first path function can be transformed into a second, different path function by application of offset in one or more dimensions. In some cases, the first path function can be transformed into a second, different path function by application of offset in two dimensions. In some cases, the first path function can be transformed into a second, different path function by application of offset in three dimensions. In some cases, the path function is independent of offset in at least one dimension of space within which the path function is executed.

Some aspects are directed to a method of transforming a first path function of a hand through at least one-dimensional space into at least a second path function in at least one-dimensional space. In some embodiments, a map can provide three-dimensional information used as the input to a three-dimensional surface map transformation to redefine a plane and/or surface and/or volume in space as in x′, y′, z′=f(x, y, z). In some embodiments, the map can be used to reorient a virtual planar keyboard at any angle, scaling factor and/or positional offset in space. In some embodiments, the surface map transformation can be represented by:

x′=f₁(x, y, z)

y′=f₂(x, y, z)

z′=f₃(x, y, z)

where x is a position in a first direction (e.g., along the substrate), y is a position in a second direction perpendicular to the first direction (e.g., in the substrate), and z is a position in a third direction perpendicular to both the first and second directions (e.g., perpendicular to the substrate). In some embodiments, f₁, f₂, and f₃ are the space-mapping transformations that enable (x′, y′, z′) to represent a transformed set of coordinates derived from the true body part position (x,y,z) and/or an error-corrected body part position.

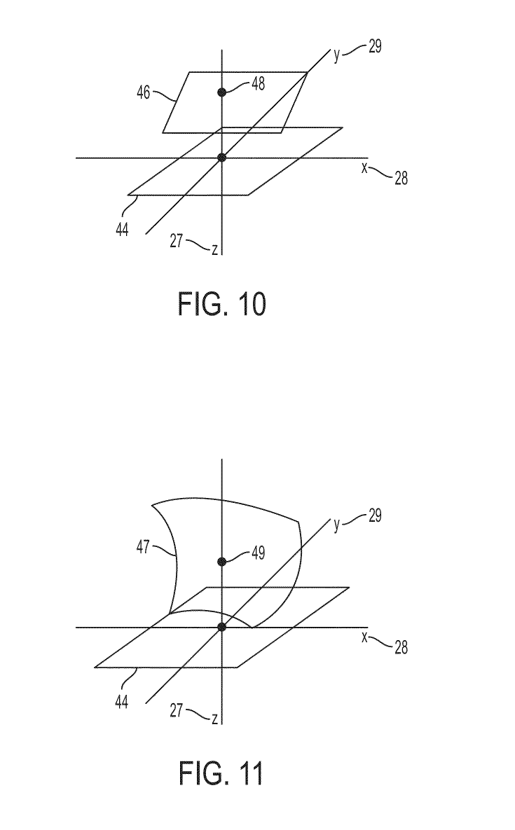

FIG. 10 illustrates an xyz coordinate system formed by x-axis 28, y-axis 29, and z-axis 27 and an area map in xy plane 44. Area map 44 can be derived from any map (e.g., a more ergonomically convenient map for a person to control functions from). For example, FIG. 10 shows a 3D planar xyz map 46. Map 46 can act as a source map that is transformed into area map 44 in the xy plane. FIG. 10 also shows intersection 48 of z-axis 27 with 3D planar xyz map 46. FIG. 11 shows an xyz coordinate system formed by x-axis 28, y-axis 29, and z-axis 27 and an area map in xy plane 44. FIG. 11 also shows arbitrary curved 3D map 47. Arbitrary curved map 47 can act as a source map that is transformed into area map 44 in the xy plane.

Some aspects are directed to a two-hand controller. For example, the position and/or motion of a first hand can result in a first set of actions and/or functions, and the position and/or motion of a second hand can result in a second set of actions. In some embodiments, one or more actions and/or functions require both the first hand and second hand to be in a particular location and/or move along a particular path.

Some aspects are directed to systems comprising a moveable capacitive plate that can rotate into and out of the plane of a substrate. The substrate may comprise a flexible, rigid, and/or semi-rigid material. In some embodiments, the substrate displays one or more ads. In some embodiments, the system further comprises circuitry capable of producing measureable change of a parameter as a function of capacitance of at least one capacitive plate (e.g., the moveable capacitive plate). The system may additionally comprise a power supply and a processor.

In some embodiments, the moveable capacitive plate can be electrically altered by the presence and/or motion of a human body part within an area. In some embodiments, the presence and/or motion of a human body part within an area can be quantified to produce at least one position and/or location of the human body part. In some embodiments, the presence of finger and/or hand position within an area can produce a plurality of positions and/or locations of the body part. In some embodiments, there can be a function and/or action as a function (e.g., a point function, a path function) of body part position within an area. In some embodiments, the function is a path function comprising a plurality of concatenated point functions. In some embodiments, the function is an error-corrected function.

In some embodiments, the moveable capacitive plate can be temporarily locked into a position perpendicular to the substrate during operation. In some embodiments, the moveable capacitive plate can then be unlocked for retraction of the moveable capacitive plate into the plane of the substrate. In some embodiments, an array of capacitive and/or inductive elements can rotate into and out of the plane of the substrate. In certain cases, the rotating elements may advantageously increase the coverage, resolution, accuracy, and/or precision of the position of a human body part within an area.

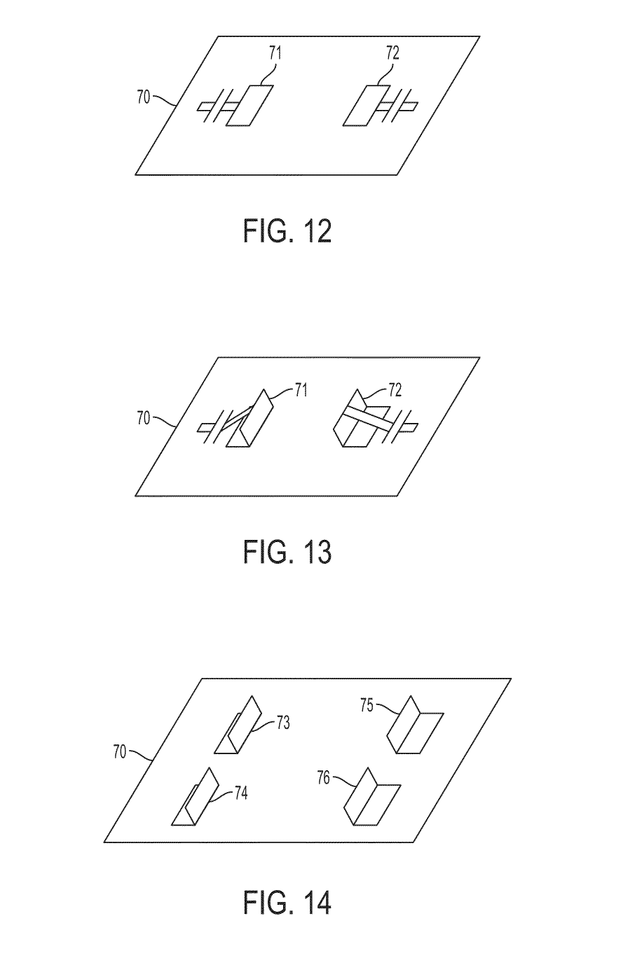

FIG. 12 illustrates a two electrode system comprising a left electrode 71 and a right electrode 72. In FIG. 12, left electrode 71 and right electrode 72 are in a retracted position within a planar substrate 70. In FIG. 13, which shows the same system, left electrode 71 and right electrode 72 are folded upward and perpendicular to the planar substrate 70. A four electrode system is shown in FIG. 14. FIG. 14 shows a planar substrate 70 and four capacitive electrodes: upper left electrode 73, lower left electrode 74, upper right electrode 75, and lower right electrode 76. In FIG. 14, electrodes 73, 74, 75, and 76 are folded upward and perpendicular to planar substrate 70. Each of electrodes 73, 74, 75, and 76 can be independently rotated in or out of the plane of planar substrate 70. In some embodiments, the electrodes can be erected, used, then folded back into the page and become flat again.

In some embodiments, the error-corrected function encompasses a tremor-stabilized error correction. The incorporation of such a function may be beneficial for people with essential tremor, Parkinson's disease, multiple sclerosis, cerebral palsy, stroke, old age, and other neurological disorders. For example, the incorporation of such a function may allow such people to enter data and communicate with computers in a more reliable manner by subtracting out uncontrolled oscillatory hand motion and allowing the average hand position to have a weighted influence on the function command desired. In some cases, tremor-stabilized error correction can involve software and filtering such that AC components of a certain frequency range and/or amplitude can be removed and/or subtracted from the DC average position. This may allow more accurate addressing of the target region in space, thus reducing incorrect data entry and subsequent issuing of incorrect function commands. In some embodiments, the software and filtering can employ digital filtering and/or moving window and/or recursive and/or non-recursive filtering techniques and/or any weighted combination thereof.

Although preferred embodiments of the present invention have been described it will be understood by those skilled in the art that the present invention should not be limited to the described preferred embodiments. Rather, various changes and modifications can be made within the spirit and scope of the present invention.

1. A system for extracting hand distance and/or position across and/or above a surface, comprising of:
a substrate;
at least one capacitive plate;
circuitry configured to produce measurable change of a parameter as a function of capacitance of said at least one capacitive plate;
a source of power; and
a processor.

2. The system of claim 1, wherein said at least one capacitive plate is at least one of the following: printed, etched, deposited, discrete, in-molded, adhesively applied, laminated within, molded, cast, stamped, a weldment and/or fabrication and/or assembly and/or subassembly, and/or any metallic and/or conductive element capable of forming one plate of a capacitor.

3. The system of claim 1, wherein said substrate is contained within a plane and/or near planar surface.

4. The system of claim 1, wherein said substrate is flexible.

5. The system of claim 1, wherein said at least one capacitive plate is two capacitive plates.

6. The system of claim 1, wherein said at least one capacitive plate is three capacitive plates.

7. The system of claim 1, wherein said at least one capacitive plate is four capacitive plates.

8. The system of claim 1, wherein said at least one capacitive plate is more than four capacitive plates.

9. The system of claim 1, wherein hand presence affects said measurable change and/or tuning by changing at least one parameter of the following: frequency, voltage, capacitance, inductance, coupling, circuit Q, quantifiable electromagnetic and/or electrostatic field distortion and/or any of the above.

10. The system of claim 1, wherein said measurable change of a parameter as a function of capacitance of said at least one capacitive plate is quantifiable over a range of hand distances and/or positions and produces at least one variable value representing at least one radius from said at least one capacitive plate.

11. The system of claim 1, wherein said at least one radius is a plurality of radii producing at least one shell in three dimensional space that maps a constant said measurable change of a parameter.

12. The system of claim 1, wherein said at least one shell in three dimensional space is two shells in three dimensional space and the intersection of said two shells in three dimensional space is at least one locus of points along an arc in three dimensional space above said substrate.

13. The system of claim 1, wherein said at least one shell in three dimensional space is at least three shells in three dimensional space and the intersection of said at least three shells in three dimensional space is at least one location in three dimensional space above said substrate.

14. The system of claim 1, wherein four or more capacitive plates provides redundancy for position sensing due to multiple combinations of three capacitive plates that is used to create overlapping solutions that is/are averaged and/or averaged in a weighted manner.

15. The system of claim 1, wherein said at least at least one location in three dimensional space is used to produce a linearized position by application of at least one mathematical equation and/or is used to produce a map that is position linearized by application of at least one mathematical equation.

16. The system of claim 1, wherein said at least one location in said three dimensional space is contained within an array of at least one dimension.

17. The system of claim 1, wherein said at least one location in said three dimensional space is contained within an array of two dimensions.

18. The system of claim 1, wherein said at least one location in said three dimensional space is contained within an array of three dimensions.

19-32. (canceled)

33. A method comprising transforming one path function of a hand through at least one dimensional space into at least one different path function in at least one dimensional space.

34-45. (canceled)

46. A system, comprising:
a substrate;
a capacitive plate, wherein the capacitive plate has a capacitance that can be altered by the presence of a human body part that is not in direct contact with the capacitive plate; and
one or more electronic devices, wherein the one or more electronic devices configured to produce a measureable change of a parameter as a function of the capacitance of the capacitive plate.

47-67. (canceled)
